(19) United States
(12) Patent Application Publication
(10) Pub. No.: US 2026/0262678 A1
(43) Pub. Date: Sep. 10, 2026

(54) Method and System for Manufacturing Pectin-Based Gummy Confections

(71) Applicant: CANDY PROS LLC, SAN DIEGO, CA (US)

(72) Inventors: Ashley Reinsmith, SAN DIEGO, CA (US); Kiley Hatch, SAN DIEGO, CA (US)

(21) Appl. No.: 19/558,412

(22) Filed: Mar. 5, 2026

Related U.S. Application Data
(60) Provisional application No. 63/767,420, filed on Mar. 5, 2025.

(51) Int. Cl. A23G 3/42; A23G 3/34; A23G 3/36; A23G 3/44

(52) U.S. Cl. CPC A23G 3/42; A23G 3/0014; A23G 3/0019; A23G 3/362; A23G 3/44

(57) ABSTRACT

A method, system, and composition for manufacturing pectin-based gummy confections using a pre-formed ready-to-melt pectin gummy base, the gummy base is provided as a solid hydrocolloid matrix in which pectin is pre-dispersed within a saccharide system and buffering system configured to maintain conditions suitable for pectin gelation, such that the pectin is incorporated within the solid matrix, that reduces or eliminates dispersion, hydration of raw pectin powders, and critical PH levels during the cook process.

### CROSS-REFERENCE TO RELATED APPLICATION

This application incorporates by reference and claims the benefit of priority to U.S. Provisional Application 63/767,420 filed on March 5, 2025.

### BACKGROUND OF THE INVENTION

### 1. Field of the Invention

This invention relates to methods and systems for manufacturing pectin-based gummy confections. More particularly, the invention relates to a method and system for producing gummy confections using a molding techniques with controlled temperature processing and optimized curing conditions.

### 2. Description of the Related Art

Gummy confections have become increasingly popular in the food industry, both as traditional candy products and as delivery vehicles for vitamins, supplements, and other active ingredients. The manufacturing of gummy confections typically involves heating a gelling agent with water and other ingredients, followed by depositing the mixture into molds and allowing the product to cure.

Conventional gummy manufacturing methods often utilize gelatin as the primary gelling agent. However, pectin-based gummies have gained popularity due to their plant-based nature, making them suitable for vegetarian and vegan consumers, as well as being more resistant to melting in hot weather. Pectin-based gummy manufacturing presents unique challenges not encountered with gelatin-based products, including more stringent temperature control requirements and different curing characteristics.

Traditional methods for filling gummy molds include depositor machines that dispense measured amounts of gummy mixture into individual mold cavities. While depositors provide precise filling, they require significant capital investment and are often impractical for small-batch production, research and development operations, or facilities with limited resources.

Small-scale producers have attempted to use manual techniques such as pipetting or pouring directly into molds, but these methods suffer from inconsistent fill volumes, air entrapment, and significant product waste. Additionally, the viscous nature of heated pectin mixtures makes precise filling difficult, and the mixture tends to skin over or set prematurely during the filling process.

Temperature control during pectin gummy manufacturing is critical. Insufficient heating can result in incomplete dissolution of the pectin base, while excessive heating may cause degradation of the pectin structure and caramelization of sugars, both of which can lead to inferior product quality. Existing manufacturing methods often lack precise temperature control protocols, resulting in inconsistent product characteristics. Pectin-based gummy systems are also highly sensitive to acid addition during processing. Introduction of an acidulant such as citric acid may initiate rapid gelation of the pectin system, which can cause the mixture to set prematurely before it can be fully deposited into molds. This rapid gelation can lead to material waste, inconsistent mold filling, and increased production inefficiencies. In addition, pectin gelation occurs within a relatively narrow pH window. If the pH is too high, gel formation may not occur, while excessively low pH conditions may cause premature gelation. As a result, conventional pectin gummy manufacturing often requires careful sequencing of ingredient addition and tight process control to maintain a workable processing window. Conventional pectin gummy formulations also typically require dispersion of dry pectin powders into high-solids sugar systems while carefully controlling hydration, pH, and temperature conditions. Improper dispersion can result in pectin clumping (commonly referred to as “fish eyes”), incomplete hydration, and inconsistent gel formation. Furthermore, pectin systems often require precise buffering and acid sequencing to initiate gelation at the correct stage of processing. These technical constraints create a narrow processing window that increases manufacturing complexity and limits scalability, particularly for small-to-medium scale producers.

Currently, there are no comprehensive methods that effectively address the challenges of small-to-medium scale pectin gummy production, including efficient mold filling, precise temperature control, optimized curing, and consistent demolding. As will be disclosed below, the present disclosure addresses these needs and covers a method and system for manufacturing pectin-based gummy confections that overcomes these limitations.

### SUMMARY OF THE INVENTION

In one aspect, the present invention is embodied as a method for manufacturing pectin-based gummy confections using a pre-buffered pectin gummy base and a flood and scrape technique that provides efficient mold filling with minimal waste and consistent product quality.

In one embodiment, the present disclosure is embodied as a multi-stage manufacturing process using a pre-buffered hydrocolloid matrix comprising: a heating and mixing stage wherein a pectin gummy base is combined with water and heated to a target temperature; a flood and scrape stage wherein the heated mixture is poured over silicone molds and spread using a heated metal scraper; a demolding stage wherein cured gummies are removed from the molds; and a coating and final cure stage wherein the gummies are coated with a sugar-based mixture or an oil coating.

In another embodiment, the disclosure is embodied as a temperature-controlled processing method wherein the pectin mixture is heated to approximately 240°F, cooled to approximately 230°F before additive incorporation, with processing temperatures maintained below a critical threshold of 262°F to prevent pectin degradation and caramelization.

In an alternative embodiment, the method includes pre-treatment of silicone molds with a release agent applied via fine mist sprayer, combined with optional freezing of molds post depositing to enhance release characteristics, particularly in humid environments.

In accordance with one form of this disclosure, there is provided a system for manufacturing pectin-based gummy confections comprising an induction heating apparatus, a mixing assembly, silicone mold trays, a heated metal scraper, or a depositor, and a controlled curing environment.

Before explaining the various embodiments of the invention in detail, it is to be understood that the invention is not limited in its application to the details of construction and to the arrangements of the components set forth in the following description or illustrated in the drawings. Rather, the invention is capable of other embodiments and of being practiced and carried out in various ways. Also, it is to be understood that the terminology employed herein is for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

For a better understanding of the invention, its operating advantages and the specific objects attained by its uses, reference should be made to the accompanying drawings and descriptive matter in which there are illustrated preferred embodiments of the invention.

Various objects, features, aspects and advantages of the present embodiment will become more apparent from the following detailed description of embodiments of the embodiment, along with the accompanying drawings in which like numerals represent like components.

### BRIEF DESCRIPTION OF THE DRAWINGS

It should be noted that the drawing figures may be in simplified form and might not be to precise scale.

FIG. 1A is a perspective view of a gelled confection being poured into a vessel in accordance with some embodiments.

FIG. 1B is a flowchart depicting the overall manufacturing process according to one embodiment of the present invention, showing the sequential stages of heating and mixing, flood and scrape molds, demolding, and coating and final cure.

FIG. 2 is a perspective view of the gelled confection undergoing reheating in the vessel in accordance with some embodiments.

FIG. 3 is a perspective view of a temperature measurement during reheating of the gelled confection in accordance with some embodiments.

FIG. 4 is a perspective view of the gelled confection being poured onto a mold tray in accordance with some embodiments.

FIG. 5 is a perspective view of a gelled confection being extracted from the mold tray after curing in accordance with some embodiments.

FIG. 6 is a perspective view of the gelled confection being coated with a coating mixture in accordance with some embodiments.

FIG. 7 is a perspective view of the gelled confection after being coated with the coating mixture in accordance with some embodiments.

The same elements or parts throughout the figures of the drawings are designated by the same reference characters, while equivalent elements bear a prime designation.

### DETAILED DESCRIPTIONOF THE INVENTION

The embodiment and various embodiments can now be better understood by turning to the following detailed description of the embodiments, which are presented as illustrated examples of the embodiment defined in the claims. It is expressly understood that the embodiment as defined by the claims may be broader than the illustrated embodiments described below. Many alterations and modifications may be made by those having ordinary skill in the art without departing from the spirit and scope of the embodiments.

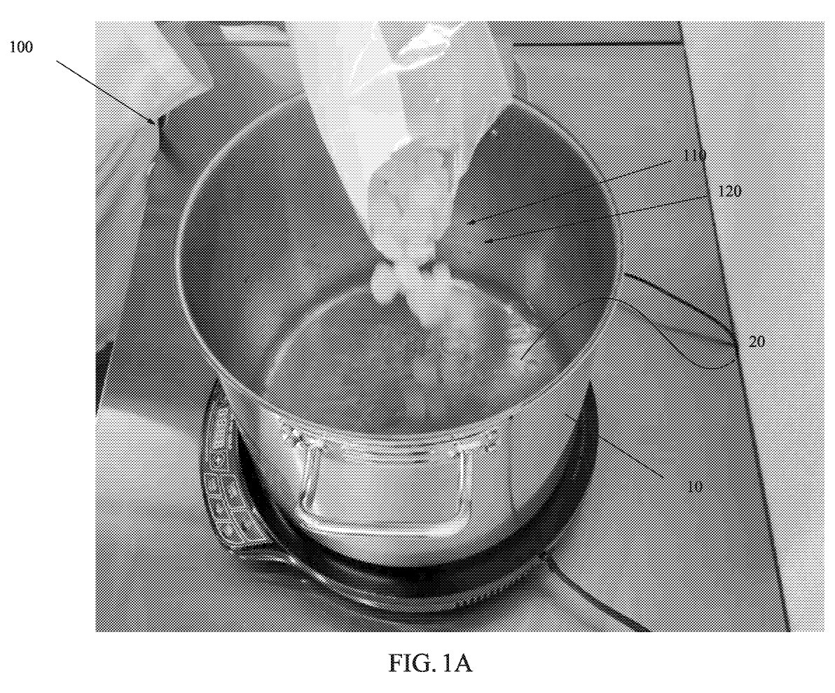

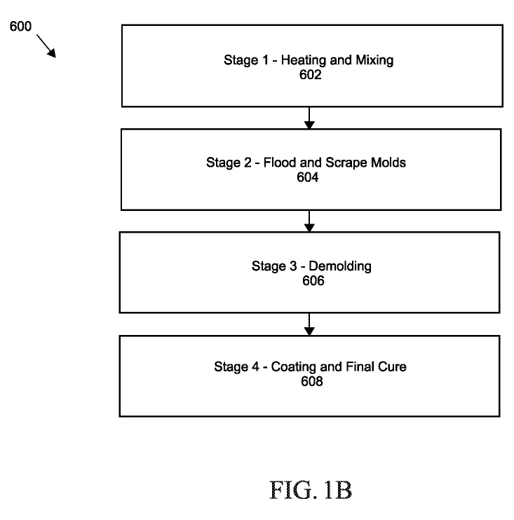

FIG. 1A is a perspective view of a gelled confection 100 being poured into a vessel 10 in accordance with some embodiments. In some embodiments, the gelled confection 100 includes a gummy base 110 and a buffering system 120, but is not limited thereto. In some embodiments, the gummy base 110 includes a pre-buffered, ready-to-melt pectin gummy base formed as a solid hydrocolloid matrix. In some embodiments, the gummy base 110 is constructed of a saccharide component selected from a glucose, sucrose, or combinations thereof, the buffering system 120 comprising citric acid and sodium citrate, pectin, and any other hydrocolloid. However, in different embodiments, other ingredients are added, such as flavoring. In some embodiments, the gummy base 110 is provided as a pre-formed, ready-to-melt pectin gummy base. The gummy base 110 is produced such that the pectin is already dispersed (i.e., a pre-dispersed hydrocolloid matrix) and incorporated within a solid hydrocolloid matrix. As a result, users of the gummy base 110 are not required to perform separate conventional pectin dispersion or hydration steps typically required when working with raw pectin powders. Moreover, the gummy base 110 does not require independent pH or Brix adjustment (sugar to water ratio). In contrast, conventional pectin gummies are liquid mixtures that are sensitive to pH adjustment and/or Brix adjustment that can affect the outcome of the pectin gummy, resulting in dispersion of the gummy prior to formation (i.e., gelling). The gummy base 110 in the present invention is ready-to-melt from a solid matrix form.

Furthermore, the gummy base 110 used in the present invention eliminates the need for independent pectin hydration steps required in conventional gummy manufacturing. In particular, pectin used in the gummy base 110 does not require hydration to activate as the gummy base 110 is already a solid and is used for reheating and reconstruction without added hydration of the pectin gummy base. The gummy base 110 is not subject to dispersion or “fish eyes” failure or clumpy appearance because the pectin gummy base is standardized for ease of use without conventional methods of careful pectin hydration and pH adjustment. Stated differently, the gummy base 110 is a pre-hydrated hydrocolloid system that reduces clumping from dry pectin powders because the gummy base 110 is already solid matrix that is ready-to-melt unlike conventional methods of using pectin.

The buffering system 120 includes citric acid and sodium citrate. The buffering system 120 operates as a buffer to facilitate pH control, gelling of the gummy base 110, and stability of the gummy base 110.

Referring now to the drawings and the characters of reference marked thereon, FIG. 1B shows a flowchart depicting an overall manufacturing process 600 for producing pectin-based gummy confections according to one embodiment of the present invention. The process 600 comprises four principal stages: Stage 1 - Heating and Mixing 602, Stage 2 - Flood and Scrape Molds 604, Stage 3 - Demolding 606, and Stage 4 - Coating and Final Cure 608.

Preparation Stage. In one embodiment, a preparation stage (Stage 0) precedes the principal manufacturing stages. During preparation, water is measured at a ratio of approximately 40% of the mass of the pectin gummy base. It is important to note that water is used with a ratio in a range of 10-60%, but 30-40% is default range. For example, for a 5-pound batch of gummy base, approximately 2 pounds of water is required. The water is added to a stainless steel pot compatible with induction heating and covered with a lid.

In one embodiment, flavoring agents are measured and set aside for later addition. Concentrated liquid flavorings are typically used at a usage rate of approximately 0.01% to 0.03% by weight. For a 5-pound batch, approximately 7 grams of concentrated flavoring may be used. Coloring agents, such as concentrated liquid-gel coloring, are similarly prepared, with approximately 10-15 drops used for a 5-pound batch. Additionally, in some embodiments,. powdered flavor and color are included.

In some embodiments, silicone mold trays are prepared by applying a thin coating of release agent, preferably MCT oil (medium-chain triglyceride oil), using a fine mist application system such as an electric paint sprayer. In different embodiments, metal molds are used for larger commercial equipment. Also, in different embodiments, starch molds are used. The mold tray is rotated 180 degrees during spraying to ensure all cavity walls are coated.

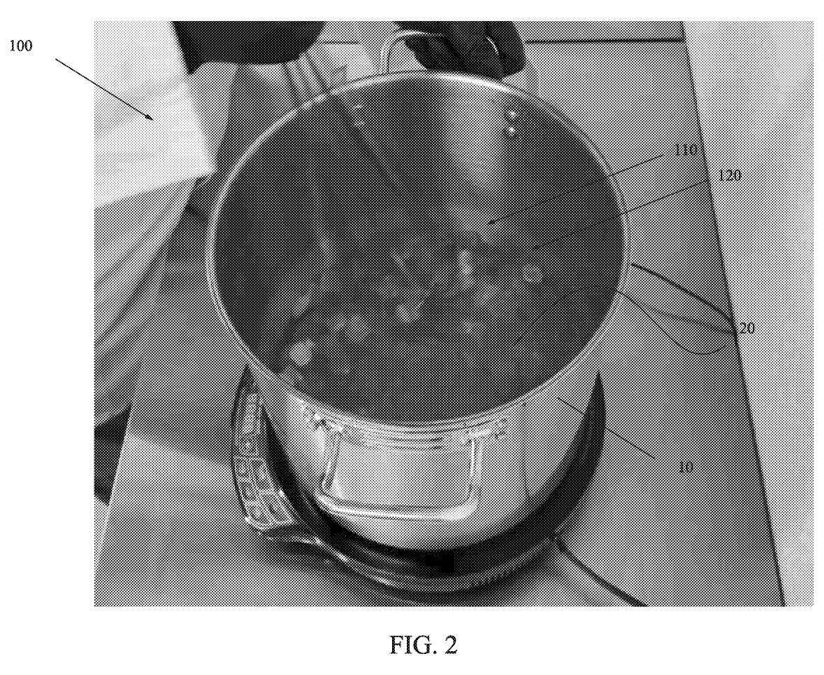

FIG. 2 is a perspective view of the gelled confection 100 undergoing reheating in the vessel 10 in accordance with some embodiments.

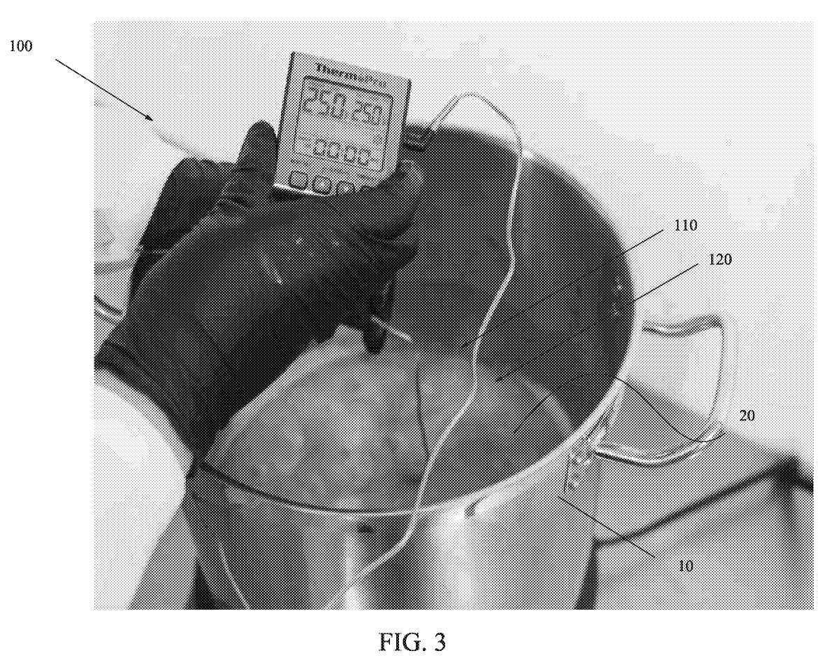

FIG. 3 is a perspective view of a temperature measurement during reheating of the gelled confection 100 in accordance with some embodiments.

Stage 1 - Heating and Mixing 602. Referring to FIGS. 1A, 2, and 3, in the heating and mixing stage 602, the covered pot containing a liquid, such as water, is placed on an induction stovetop and heated at high power until the water reaches a rolling boil at approximately 212°F. The lid is then removed and the pectin gummy base 110 is carefully added to the boiling water. In one embodiment, the combined contents should not exceed approximately 50% of the pot capacity to accommodate expansion during cooking.

The mixture is stirred with a metal whisk for approximately 3-5 minutes until the gummy base 110 begins to melt and disperse the solid hydrocolloid matrix. An immersion blender is then fully immersed in the mixture and operated until the mixture becomes completely smooth and homogeneous (often referred to as a slurry), and before any heating is initiated.

Once the gummy base 110 is completely blended, the induction stovetop temperature is set to a range of approximately 375°F to 410°F. During this phase, stirring is generally unnecessary, though gentle whisking may be performed. It is important to avoid using a spatula or similar implement that may cause flash burning at the bottom of the pot.

The mixture is heated evenly until reaching a target temperature of approximately 240°F. However, in some embodiments, the temperature used is a range of 230-260 °F. Cooking to 230°F allows for a softer texture finished gummy, cooking up to 260°F allows for the firmest and chewiest texture. The base can be cooked to any temp in this range to achieve desired texture, but must surpass 230°F. Temperature is monitored frequently using a candy thermometer, preferably a glass candy thermometer to avoid induction interference. For a 5-pound batch, this heating process typically takes approximately 45-60 minutes. The mixture will thicken progressively as water evaporates resulting in a soluble solids concentration typically between 82 and 88 Brix.

In one critical aspect of the present invention, the mixture temperature must never exceed approximately 262°F. Exceeding this critical threshold causes degradation of the pectin structure and caramelization of sugars, resulting in pouring difficulties and inferior product quality. Once the mixture temperature exceeds approximately 235°F, the temperature rises at an accelerated rate as water evaporates more rapidly, requiring increased vigilance.

Upon reaching 240°F, the heat is cut and the mixture is allowed to cool to approximately 230°F. At this temperature, flavoring agents, coloring agents, and any additional additives are incorporated. Any waxy additives should be pre-heated to approximately 160°F to 200°F to facilitate incorporation. A metal whisk is used to gently and evenly distribute the additives throughout the mixture.

In different embodiments, the pre-buffered gummy base 110 is heated using a microwave without requiring specialized confectionery cooking equipment. For example, the gummy base 110 is inserted into a microwave safe container that has a handle, and it is preferable to be able to see through the container as well. The size of the container should allow for the gummy base 110 to only sit as far as to halfway fill the container. Thereafter, add 5% (with a range of 3-10%) of water by weight as compared to the base. Shake the gummy base 110 (i.e., cubes) to try to get them all damp with water.

Microwave the gummy base 110 for 3-5 minutes, or until the gummy base 110 begins to boil and rise in the container. Carefully remove the gummy base 110 from the microwave and stir it well. The gummy base 110 should be mostly, if not all, melted at this point. Place the container back in the microwave and continue for an additional energy level (e.g., high) for a period of time (e.g., 30-90 seconds), or until the gummy base 110, as a molten mass, rises towards the top of the container again. Mix and scrape the sides of the container and you will be ready to pour the molten mass on to your molds and follow the process as normal from that point. It is important to note that the molten mass is considered a state of the gummy base 110 and the buffering system 120 after reheating is complete, such that the gummy base 110 and the buffering system 120 are melted in the water and have reached a predetermined temperature, such as, for example 230°F.

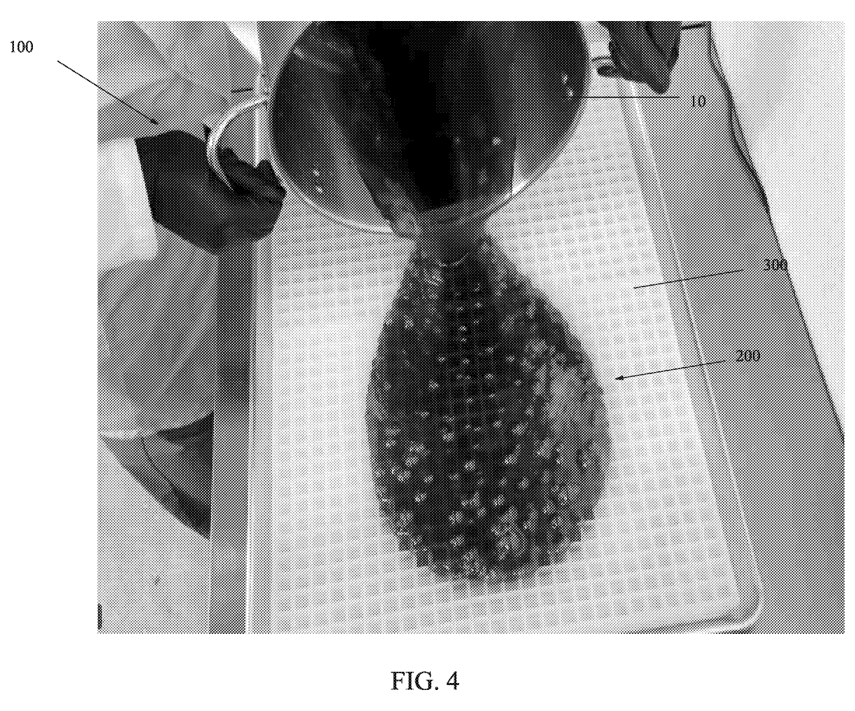

Stage 2 - Flood and Scrape Molds 604. Referring to FIG. 4, the flood and scrape stage 604 is a time and temperature sensitive operation that allows rapid filling of multiple cavities while minimizing premature gelation of the pectin system. A metal scraper is pre-heated using a heat gun. The heated pectin mixture (a.k.a., molten mass 200) is quickly poured over the prepared silicone mold trays 300 in a flooding action, covering all cavities.

The heated metal scraper is then used to rapidly spread the molten mass 200 across the mold surface 300, ensuring that all mold cavities are filled completely and evenly. The use of a heated scraper prevents premature cooling and skinning of the molten mass 200 during the scraping operation. Excess mixture is scraped from the ridges between cavities, which facilitates the subsequent demolding operation. This ridge scraping is particularly important when using irregular cavity designs or molds with flat top surfaces.

As shown in FIG. 4, the flood and scrape technique results in cavities filled to a consistent level with minimal air entrapment. The technique allows for efficient filling of multiple cavities simultaneously with minimal waste, as excess of the molten mass 200 can be scraped to adjacent mold trays 300.

Once the mold tray 300 is evenly filled, it is transferred to a drying rack or suitable flat surface for curing and drying.

In an alternative embodiment suitable for larger-scale production, a mechanical depositor, not shown for clarity, may be used instead of the flood and scrape technique. The depositor nozzles and hopper are heated and configured to evenly fill the mold cavities with measured amounts of the pectin mixture. In some embodiments, a depositor includes a candy depositor and a hand depositor, but is not limited thereto. The deposit is used for filling candy molds.

Stage 3 - Demolding 606. In the demolding stage 606, the filled mold trays are transferred to a controlled curing environment. In one embodiment, the trays are placed in a freezer. In another embodiment, the trays are placed in a climate-controlled environment maintained at approximately 27% relative humidity or less. (can be done in under 50% humidity or less, with under 30% being most ideal for gummy making)

Curing time varies based on environmental conditions, gummy size, and shape. In high humidity environments, curing may take 18 hours or longer, while in dry, cold environments, curing may complete in less than one hour. The recommended curing environment is 27-50% relative humidity at temperatures not exceeding approximately 70°F.

In one embodiment, curing time may be reduced by placing the mold trays in a freezer until the gummy surface temperature reaches approximately 25°F, after which the gummies may proceed directly to demolding.

When the gummies have sufficiently cured to retain their shape, they are ready for demolding. The mold tray is carefully inverted and gentle pressure is applied to pop the gummies from the mold cavities onto a sheet pan. For optimal demolding, the operation should be performed immediately after removing the tray from the freezer, as the (firm gummies will be easier to release and...) cold gummies will absorb atmospheric moisture, which enhances subsequent sugar coating adhesion.

After demolding, the gummies are inspected for proper shaping, and any rough edges or tailings from the mold cavity tops are trimmed.

Furthermore, in some embodiments, the gummy base 110 and the buffering system 120 are included together as a ready-to-make gummy manufacturing system. To illustrate, the ready-to-make gummy manufacturing system will be a kit or package that includes the gummy base 110 and the buffering system 120 with instructions. In different embodiments, the ready-to-make gummy manufacturing system includes the gummy base 110 and the buffering system 120, instructions, flavoring, coloring, gummy molds, heating vessels, scraper or spatula, and/or finishing/coating products such as a sugar mixture, anti-stick agent, or other candy toppings or inclusions.

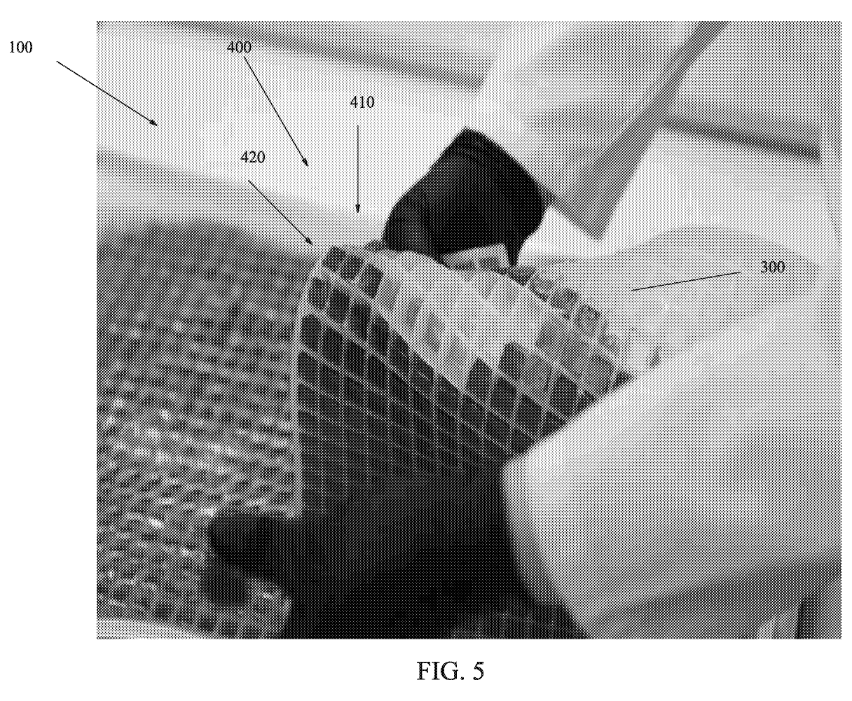

FIG. 5 is a perspective view of a gelled confection 400 being extracted from the mold tray 300 after curing in accordance with some embodiments.

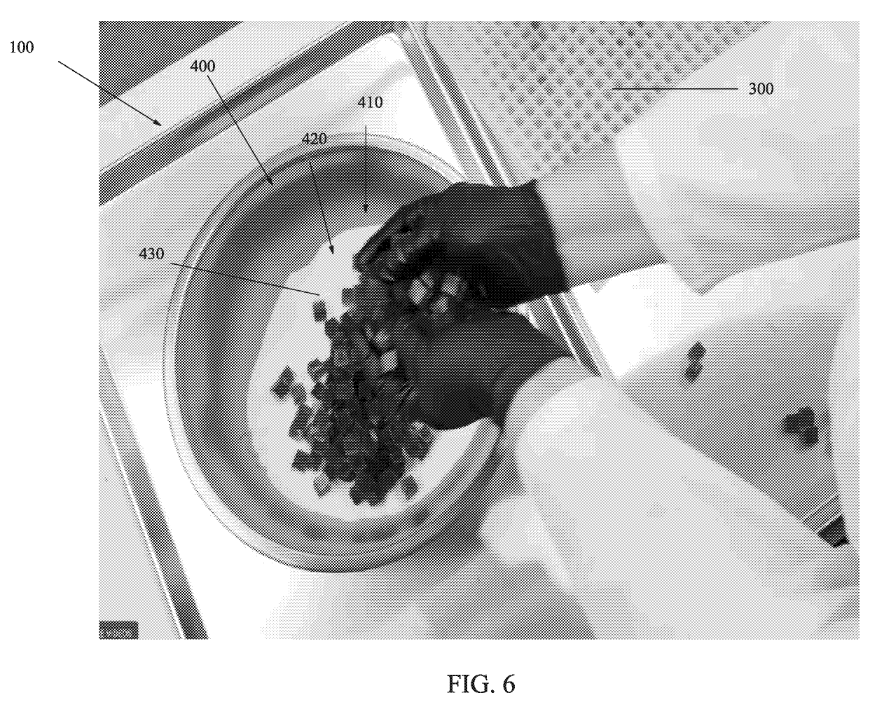

FIG. 6 is a perspective view of the gelled confection 400 being coated with a coating mixture 420 in accordance with some embodiments.

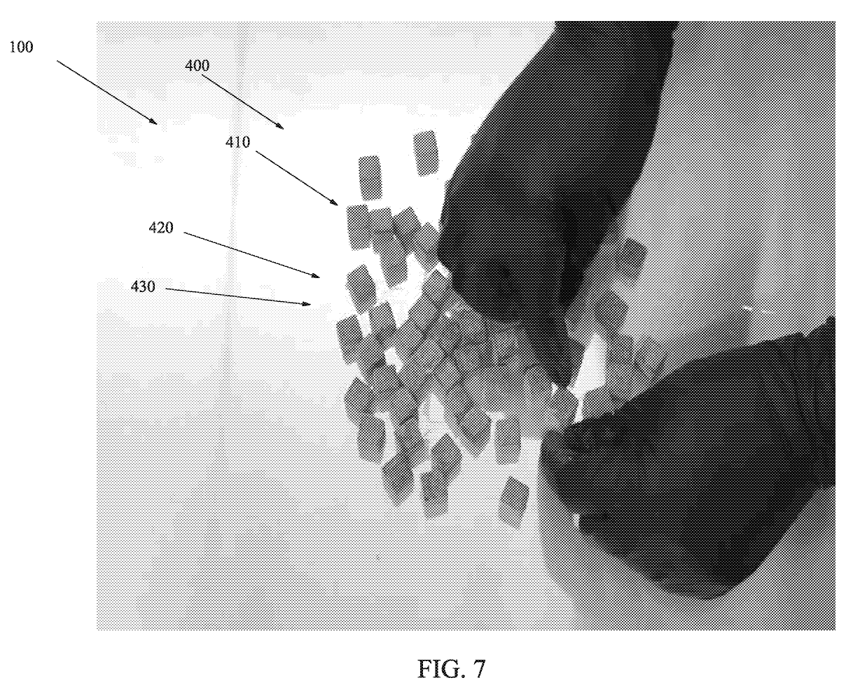

FIG. 7 is a perspective view of the gelled confection 400 being coated with the coating mixture 420 in accordance with some embodiments.

In the depicted example of FIGS. 5-7, the gelled confection 400 is a solidified matrix of the molten mass 200. The gelled confection 400 is essentially a re-solidified form of the gelled confection 100. Thus, in some embodiments, the gelled confection 400 includes a gummy base 410, a buffering system 420, and a coating mixture 430, but is not limited thereto. Since the gummy base 410 and the coating mixture 420 are similar to the gummy base 110 and the buffering system 120 discussed above, further description will not be repeated.

In some embodiments, the gelled confection 400 includes a nutraceutical active, botanical, pharmaceutical, or functional food active, disposed within the gummy base 410 after melting and prior to resolidifying.

Stage 4 - Coating and Final Cure 608. Referring to FIGS. 5-7, in the coating and final cure stage 608, a stainless steel bowl is filled with a sugar-based coating mixture or an oil coating. In one embodiment, the coating mixture 430 comprises approximately 90% fine granulated sugar and approximately 10% encapsulated citric acid. Encapsulated malic acid may be used alternatively or in combination with citric acid. It is important to note that citric acid and malic acid are both optional to taste preference. In some embodiments, an 8:1:1 ratio mixture of sugar, citric acid, and malic acid is used, and adjusting to taste. They can be sanded with only sugar, or alternatively a carnauba wax oil mixture and commercial anti-stick agent that is sprayed or drizzled on, and then tumbled for even coating. In some embodiments, oil is used for a smoother texture instead of sugar for sanding.

The demolded gummies (i.e., the gummy base 410) are placed into the sugar coating mixture 430 and tossed until consistently and sufficiently coated. Care is taken to prevent gummies from stacking or sticking together during the coating operation.

In some embodiments, if sugar does not adhere consistently to the exposed face of the gummy (the face that was at the top of the mold cavity), a light mist of water may be applied to the gummies prior to or during the sugaring operation to improve cohesion.

Excess sugar is removed by tossing the coated gummies in a wire basket or sieve. The coated gummies are then placed individually on a sheet pan, covered with parchment paper, and allowed to rest and fully cure to the desired bite texture prior to packaging.

Re-Processing Embodiment. In one embodiment, the present invention includes a method for re-processing or de-webbing previously manufactured pectin gummies. This method allows for recycling of defective or out-of-specification product. The re-processing method follows similar stages but includes an initial de-webbing stage wherein previously formed gummies are dissolved in heated water.

In the re-processing embodiment, water is measured at 40% of the mass of the gummies to be re-processed. The water is brought to a rolling boil with a lid to prevent evaporation. The gummies are added to the boiling water, with the contents not exceeding 50% of the pot capacity. The lid is removed and the mixture is vigorously stirred with a metal whisk for 5-7 minutes until approximately 95% dissolved.

Once substantially dissolved, the stovetop temperature is reduced and occasional low-shear stirring with a whisk is performed. The mixture is then processed through the standard heating, flooding, curing, demolding, and coating stages as described above.

As discussed above, the gummy base 110 is a simplified pre-buffered hydrocolloid-based delivery system that eliminates user-induced variability in small-to-mid-scale confection production, and is suitable for incorporating nutraceutical, botanical, cannabinoid, vitamin, peptide, or functional food active ingredients. It reduces commercial pain points such as formulation complexity, technical barrier, manufacturing error, and greatly reduces production time.

It is to be understood that the present disclosure encompasses a comprehensive pectin gummy manufacturing system utilizing an induction heating apparatus, a mixing assembly comprising a gummy base pectin, molds such as silicone mold trays, a filling apparatus such as a heated metal scraper or a mechanical depositor, and a controlled curing environment. Furthermore, the functional benefits of the present invention, namely, the elimination of separate pectin hydration, dispersion, and critical pH adjustment steps; are directly derived from the structural configuration of the pre-buffered pectin gummy base. Specifically, this base comprises a pre-hydrated and pre-dispersed hydrocolloid network incorporated within a solid confectionery matrix. This specialized structural configuration allows the system to bypass the conventional vulnerabilities associated with hydrating dry pectin powder, such as incomplete dispersion or the formation of clumping (commonly referred to as "fish eyes").

Regarding the heating and mixing stages, the sequence of operations is precisely controlled to protect the structural integrity of the pectin. Any blending to create a smooth, homogeneous slurry, such as via an immersion blender, is performed after the solid base is added to the initially boiling liquid, but specifically before the secondary, higher-temperature induction heating stage (e.g., 375°F to 410°F) is initiated. During this secondary heating phase, or any subsequent heating stage, it is a critical aspect of the invention that the mixture temperature must never exceed approximately 262°F. Exceeding this critical temperature threshold causes degradation of the pectin structure, caramelization of sugars, and ultimately results in inferior product quality. By maintaining the heating within a specified operational range, such as 230°F to 260°F, the resulting molten mass steadily evaporates to achieve a desired soluble solids concentration, which is typically between 82 and 88 Brix, and fully encompasses specific formulations requiring an exact concentration of 86 Brix.

Finally, the liquid utilized to dissolve and melt the base across various embodiments is carefully calibrated depending on the specific manufacturing method being employed. The liquid-to-base mass ratio broadly encompasses 10% to 60% for standard stovetop preparation, with a preferred default range of 30% to 40% water by weight. For low-volume microwave processing, the liquid is added at a considerably lower relative weight in the range of 3% to 10%, and more specifically 3% to 7% by weight. Furthermore, when performing the re-processing or "de-webbing" embodiment to recycle previously manufactured pectin gummies, water is carefully measured at approximately 40% of the mass of the defective gummies to be re-processed and is brought to a rolling boil within a covered vessel to strictly prevent evaporation prior to dissolution.

In yet another embodiment, the present disclosure provides a ready-to-make gummy manufacturing system configured as a comprehensive consumer kit or package for at-home or small-scale production. At a minimum, this consumer kit comprises the pre-buffered gummy base incorporated with the buffering system, alongside detailed instructions for preparation. To facilitate various preparation methods, such as stovetop or microwave heating, the kit may optionally encompass specialized hardware, including but not limited to heating vessels such as microwave-safe containers with handles, a scraper or spatula to execute the flood and scrape technique, and gummy molds which may be constructed from silicone, metal, or starch. Furthermore, the kit can provide a highly customizable experience by including an array of pre-measured additives, such as concentrated liquid or powdered flavorings, liquid-gel or powdered coloring agents, and various active ingredients selected from nutraceutical, botanical, pharmaceutical, or functional food actives. Finally, to complete the manufacturing process, the kit may include pre-measured finishing and demolding products, encompassing mold release agents such as medium-chain triglyceride (MCT) oil, as well as final coating mixtures such as fine granulated sugar, encapsulated citric acid, encapsulated malic acid, carnauba wax oil mixtures, commercial anti-stick agents, or other candy toppings and inclusion.

As mentioned above, other embodiments and configurations may be devised without departing from the spirit of the invention and the scope of the appended claims.

1. A method, comprising:
providing a pre-buffered pectin gummy base based on a solid confectionery matrix;
heating the pre-buffered pectin gummy base in a vessel to dissolve the pre-buffered pectin gummy base and form a molten mass; and
depositing the molten mass into a mold.

2. The method of claim 1, wherein providing the pre-buffered pectin gummy base comprises at least one of a saccharide component, a gelling hydrocolloid, and a buffering system.

3. The method of claim 1, wherein providing the pre-buffered pectin gummy base eliminates a separate pectin dispersion step during preparation of the molten mass based on a pre-dispersed hydrocolloid matrix.

4. The method of claim 1, wherein providing the pre-buffered pectin gummy base reduces clumping associated with hydration of dry pectin powders based on a pre-hydrated hydrocolloid system.

5. The method of claim 1, wherein providing the pre-buffered pectin gummy base avoids at least one of hydrocolloid hydration and pH adjustment based on the construction of the pre-buffered pectin gummy base.

6. The method of claim 1, wherein the pre-buffered pectin gummy base comprises previously a manufactured pectin gummies, and wherein heating the pre-buffered pectin gummy base comprises adding water at approximately 40% of a mass of the previously manufactured pectin gummies, bringing the water to a boil in the vessel with a lid to prevent evaporation, adding the previously manufactured pectin gummies to the boiling water, and stirring the mixture until the previously manufactured pectin gummies are substantially dissolved.

7. The method of claim 1, wherein heating the pre-buffered pectin gummy base comprises heating the pre-buffered pectin gummy base in a temperature range of 230°F to 262°F.

8. The method of claim 1, further comprising inserting at least one of a nutraceutical active, a botanical active, a pharmaceutical active, and a functional food active into the molten mass after forming the molten mass.

9. A method, comprising:
providing a pre-buffered pectin gummy base based on a solid confectionery matrix in a container;
adding a liquid to the container with a relative weight less than a weight of the pre-buffered pectin gummy base;
heating the pre-buffered pectin gummy base with microwave radiation to at least partially boil the pre-buffered pectin gummy base and form a molten mass; and
depositing the molten mass into a mold.

10. The method of claim 9, wherein adding the liquid to the container comprises adding the liquid with the relative weight in a range of an amount sufficient to facilitate melting with respect to the weight of the pre-buffered pectin gummy base.

11. The method of claim 10, wherein adding the liquid with the relative weight facilitates reproduction of the pre-buffered pectin gummy base from the mold.

12. The method of claim 10, wherein adding the liquid with the relative weight in the range comprises adding the liquid with the relative weight in the range of 3 to 7 percent by weight.

13. The method of claim 9, wherein heating the pre-buffered pectin gummy base prevents premature gelation of the pre-buffered pectin gummy base.

14. The method of claim 9, wherein providing the pre-buffered pectin gummy base comprises at least one of a saccharide component, a gelling hydrocolloid, and a buffering system.

15. The method of claim 14, wherein providing the pre-buffered pectin gummy base facilitates reproduction of the pre-buffered pectin gummy base with the same characteristics of the pre-buffered pectin gummy base prior to heating based on the construction of the pre-buffered pectin gummy base.

16. A gelled composition, comprising:
a pectin gummy base based on a solid confectionery matrix;
a buffering system disposed within at least a portion of the pectin gummy base; and
a brix concentration between 82 Brix and 88 Brix.

17. The gelled composition of claim 16, wherein the pectin gummy base is constructed of at least one of a saccharide component and a gelling hydrocolloid.

18. The gelled composition of claim 16, wherein the buffering system comprises citric acid and sodium citrate.

19. The gelled composition of claim 16, wherein the pectin gummy base is configured to at least partially eliminate pectin hydration.

20. The gelled composition of claim 16, wherein the pectin gummy base is configured to at least partially prevent pH adjustment based on receiving acid.
